(19) United States
(12) Patent Application Publication
(10) Pub. No.: US 2015/0209820 A1
(43) Pub. Date: Jul. 30, 2015

(54) GLUE GUN

(71) Applicant: TECHNOS CO., LTD., Chiba (JP)

(72) Inventor: Kazuhiko Ono, Chiba (JP)

(21) Appl. No.: 14/687,818

(22) Filed: Apr. 15, 2015

Related U.S. Application Data
(63) Continuation of application No. PCT/JP2014/074192, filed on Sep. 12, 2014.

(30) Foreign Application Priority Data
Sep. 17, 2013 (JP) 2013-191465

(51) Int. Cl. B05C 17/005

(52) U.S. Cl. CPC B05C 17/0053; B05C 17/0052

(57) ABSTRACT

A glue gun includes a melt portion configured to receive a stick-shaped hot melt adhesive, and then heat, melt, and inject the hot melt adhesive. The melt portion has an inlet opening to receive the stick-shaped hot melt adhesive, and an outlet opening to inject liquid hot melt adhesive. The liquid hot melt adhesive is prepared by heating and melting the stick-shaped hot melt adhesive. The inlet opening communicates with the outlet opening via a plurality of passages.

### CROSS-REFERENCE TO RELATED APPLICATION

The present application is a Continuation and claims benefit, pursuant to 35 U.S.C. §120, of International Patent Application No. PCT/JP2014/074192 filed on Sep. 12, 2014, which is based upon and claims benefit of priority from the prior Japanese Patent Application No. 2013-191465, filed on Sep. 17, 2013, which is incorporated by reference in its entirety herein.

### TECHNICAL FIELD

The present invention relates to a glue gun that heats and melts a stick-shaped hot melt adhesive, and injects the hot melt adhesive.

### BACKGROUND ART

Conventionally, a hot melt adhesive (hot glue) is used as an adhesive for closing (sealing) a corrugated paperboard carton, for packaging a medicine or cosmetics, for assembling a woodwork, and for other purposes. The hot melt adhesive is an adhesive that may include ethylene-vinyl acetate (EVA), or thermoplastic resin such as polyamide and acrylic resin. In professional use, an application device, which is referred to as a hot melt applicator, is usually used. In the hot melt applicator, the hot melt adhesive is melted in a tank having a capacity of from several liters to several tens liters. The melted adhesive is pumped up such that the melted adhesive moves through parts, such as a heater hose and an automatic gun, and is applied.

On the other hand, when such adhesive application device is used with a relatively small amount of adhesive (e.g., for making a wreath, for a dried flower arrangement, in handcraft classes at elementary and middle schools, or for hair extension at a beauty parlor) or used for a hobby, the adhesive application device is a tool having a simple (handy) and portable structure. Such tool is referred to as a glue gun. As disclosed in Patent Literatures 1 to 3 (will be mentioned below), for example, the glue gun uses a hot melt adhesive, which is formed in a solid cylindrical stick shape beforehand. This stick is often referred to as a glue stick. The glue stick is pushed into a metallic passage, which has an associated built-in heater. The glue stick is heated to a hundred and several tens degrees C. and melted in the passage. Then, the melted (molten) glue is injected from a nozzle (outlet) at an end of the passage by a desired amount at each injection such that the melted glue is applied to a target area.

The above-mentioned hot melt applicator requires a power source and a compressed air (air compressor), and therefore the hot melt applicator is extremely difficult to move from one place to another place. Also, the hot melt applicator is expensive. On the contrary, the glue gun is hand-held (hand carry) tool, which is similar to an electric drill and a soldering iron. Because the glue gun does not make user's hands sticky, and enables quick bonding, the glue gun is conventionally used for handcrafts. As the usability, the workability, and the inexpensive cost are recognized, use of the glue gun rapidly expands in the industrial use. For example, the glue gun is most suitable for packaging a small volume of different kinds of goods. Recently, the glue gun is more used as a tool to bond and fix automobile parts and electric parts.

### LISTING OF REFERENCES

### Patent Literatures

PATENT LITERATURE 1: Japanese Patent Application Laid-Open (Kokai) Publication No. 2004-188400
PATENT LITERATURE 2: Japanese Utility Model Registration No. 3058627
PATENT LITERATURE 3: Japanese Utility Model Registration No. 3149451

### SUMMARY OF THE INVENTION

The conventional glue guns have the following problems. Specifically, the hot melt adhesive is made from a resin (thermoplastic resin) having a low thermal conductivity. Thus, the hot melt adhesive is not melted quickly even if the hot melt adhesive is heated by a heater. In order to obtain a sufficient bonding force, the hot melt adhesive needs to be heated to an even higher temperature after the melting. For example, when the primary material of the hot melt adhesive is EVA, the hot melt adhesive has the following property, i.e., the hot melt adhesive starts softening at about 100 degrees C., and demonstrates a sufficient bonding force at the temperature of 160-180 degrees C. The softening is confirmed by a measuring method defined in JISK-6863.

If a user does not understand this property sufficiently, the user may keep pulling a trigger while the hot melt adhesive have a high viscosity. The hot melt adhesive has a high viscosity when the hot melt adhesive starts softening. If the hot melt adhesive having a high viscosity is squeezed out, this would cause the clogging of a ball valve in a nozzle. If the user continues to pull the trigger from this situation in order to forcibly inject the melted adhesive, the melted adhesive flows backward inside and solidifies in a silicon sleeve at an entrance. If this happens, the trigger cannot move, and the glue gun may become beyond repair. In addition, the inside capacity of the conventional glue gun is small so that the conventional glue gun cannot inject the adhesive continuously. When the bonding work should continuously be carried out, two or more glue guns are prepared and used alternately. This is troublesome in industrial use.

The present invention is to provide a novel glue gun that can efficiently heat and melt the hot melt adhesive in a short time, and can inject the melted adhesive continuously.

A first aspect of the present invention provides a glue gun that includes a melt portion configured to receive a stick-shaped hot melt adhesive, and then heat, melt, and inject the hot melt adhesive. The melt portion has an inlet opening to receive the stick-shaped hot melt adhesive, and an outlet opening to inject liquid hot melt adhesive. The liquid hot melt adhesive is prepared by heating and melting the stick-shaped hot melt adhesive. The inlet opening communicates with the outlet opening via a plurality of passages.

With this configuration, the stick-shaped hot melt adhesive is branched into a plurality of passages after the hot melt adhesive is introduced into the melt portion from the inlet opening. Then, the branched hot melt adhesive is moved toward the outlet opening. This increases the contact area between the hot melt adhesive and the base material of the melt portion. Therefore, it is possible to efficiently heat and melt the hot melt adhesive, raise the temperature of the hot melt adhesive to the bonding temperature in a short time, and continuously inject the hot melt adhesive.

The second aspect of the present invention is directed to the glue gun according to the first aspect, and further includes a cutting blade unit disposed at the inlet opening and configured to cut the hot melt adhesive radially, with an axis of the hot melt adhesive being the center of radial cutting. With this configuration, the cutting blade unit can divide the stick-shaped hot melt adhesive into a plurality of pieces immediately after the hot melt adhesive is received in the melt portion. After the dividing, it is possible to efficiently heat and melt the resulting pieces of hot melt adhesive.

The third aspect of the present invention provides another glue gun that includes a melt portion configured to receive a stick-shaped hot melt adhesive, and then heat, melt, and inject the hot melt adhesive. The melt portion has an inlet opening to receive the stick-shaped hot melt adhesive, and an outlet opening to inject liquid hot melt adhesive. The liquid hot melt adhesive is prepared by heating and melting the stick-shaped hot melt adhesive. A cutting blade unit is disposed in a first passage extending inward from the inlet opening. The cutting blade unit is configured to cut the hot melt adhesive radially, with an axis of the hot melt adhesive being the center of radial cutting. A second passage having a conical shape is formed downstream of the first passage. The second passage is configured to spread the hot melt adhesive radially from a center of the hot melt adhesive while guiding the hot melt adhesive to a downstream side. Third passages extend from the second passage toward the outlet opening, and are arranged in a generally annular form. The third passages merge with each other near the outlet opening and communicate with the outlet opening.

This configuration increases the contact area between the hot melt adhesive and the base material of the melt portion. This is similar to the first aspect of the invention. Therefore, it is possible to efficiently heat and melt the hot melt adhesive, raise the temperature of the hot melt adhesive to the bonding temperature in a short time, and continuously inject the hot melt adhesive. In addition, the cutting blade unit can divide the stick-shaped hot melt adhesive into a plurality of pieces immediately after the hot melt adhesive is introduced to the melt portion. After the dividing, therefore, it is possible to efficiently heat and melt the resulting pieces of hot melt adhesive. This is similar to the second aspect of the invention.

The fourth aspect of the present invention is directed to the glue gun according to the third aspect, and the third passages have a larger volume on a downstream side than on an upstream side. With this configuration, it is possible to hold (retain) a large amount of hot melt adhesive, which is heated, melted and has reached the bonding temperature, in the melt portion. Accordingly, it is possible to continuously inject the adhesive, and ensure efficient bonding work.

The fifth aspect of the present invention is directed to the glue gun according to the third aspect or the fourth aspect, and the third passages are separate in a circumferential direction of the generally annular form. With this configuration, the contact area between the hot melt adhesive and the base material of the melt portion increases. Therefore, it is possible to efficiently heat and melt the hot melt adhesive, raise the temperature of the hot melt adhesive to the boding temperature in a short time, and inject the hot melt adhesive continuously. This is similar to the first and third aspects of the invention.

The sixth aspect of the present invention is directed to the glue gun according to the fifth aspect, and each of the third passages is circular in its cross-section. This configuration allows the hot melt adhesive to smoothly move through the third passages. It is also possible to easily prepare the third passages by plaster casting, extrusion, lost wax casting, or the like.

The seventh aspect of the present invention is directed to the glue gun according to any one of the third to sixth aspects, and the cutting blade unit includes a plurality of blades that extend from a wall of the first passage toward a center of the first passage. Each of the blades gradually increases its height from an upstream side of the first passage to a downstream side of the first passage. With this configuration, it is possible to smoothly cut the hot melt adhesive without receiving a large resistance.

The eighth aspect of the present invention is directed to the glue gun according to any one of the third to seventh aspects, and the glue gun further includes a plate heater that extends around a substantially entire outer surface of the melt portion. With this configuration, it is possible to uniformly heat the entire melt portion without irregularities.

The present invention has, for example, the following advantages: (1) The contact area between the hot melt adhesive and the base material of the melt portion increases. Therefore, it is possible to efficiently heat and melt the hot melt adhesive, raise the temperature of the hot melt adhesive to the bonding temperature in a short time, and continuously inject the hot melt adhesive. (2) The cutting blade unit can divide the stick-shaped hot melt adhesive into a plurality of pieces immediately after the hot melt adhesive is received in the melt portion. After the dividing, therefore, it is possible to efficiently heat and melt the resulting pieces of hot melt adhesive. (3) It is possible to hold a large amount of hot melt adhesive, which is heated, melted and has reached the bonding temperature, in the melt portion. Accordingly, it is possible to continuously inject the adhesive, and ensure efficient bonding work.

### BRIEF DESCRIPTION OF THE DRAWINGS

FIG. 1 shows an outside appearance of a glue gun 100 according to one embodiment of the present invention.

FIG. 2 is a vertical cross-sectional view of a melt portion 40 of the glue gun 100 according to the present invention.

FIG. 3 is a cross-sectional view taken along the line a-a in FIG. 2.

FIG. 4 is an exploded view showing a structure of the melt portion 40 shown in FIG. 2.

FIG. 5(b) is a drawing when viewed in the b-direction in FIG. 4. FIG. 5(c) is a drawing when viewed in the c-direction in FIG. 4. FIG. 5(d) is a drawing when viewed in the d-direction in FIG. 4. FIG. 5(e) is a drawing when viewed in the e-direction in FIG. 4.

FIG. 6(1) schematically illustrates a hot melt adhesive 50 immediately before the hot melt adhesive is introduced into the melt portion 40. FIG. 6(2) schematically illustrates the hot melt adhesive 50 immediately after the hot melt adhesive is introduced into the melt portion 40. FIG. 6(3) schematically illustrates the hot melt adhesive 50 that is cut by a cutting blade unit 80d after the hot melt adhesive 50 is introduced into the melt portion 40.

FIG. 7(4) schematically illustrates the hot melt adhesive 50 that moves through a second passage having a conical shape. FIG. 7(5) schematically illustrates the hot melt adhesive 50 that moves from the second passage to a third passage. FIG. 7(6) schematically illustrates the hot melt adhesive 50 immediately before the hot melt adhesive merges at an end of the third passage. FIG. 7(7) schematically illustrates the hot melt adhesive 50 that is injected from an outlet opening 83b.

FIG. 8 shows cross-sectional views (1)-(7) of the hot melt adhesive, which correspond to FIGS. 6(1) to 6(3) and 7(4) to 7(7) respectively.

FIGS. 9(A)-9(D) show a set of front views showing other embodiments with respect to the second passages 81b of the melt portion 40.

FIGS. 10(A)-10(F) show another set of front views showing other embodiments with respect to the second passages 81b of the melt portion 40.

### DETAILED DESCRIPTION

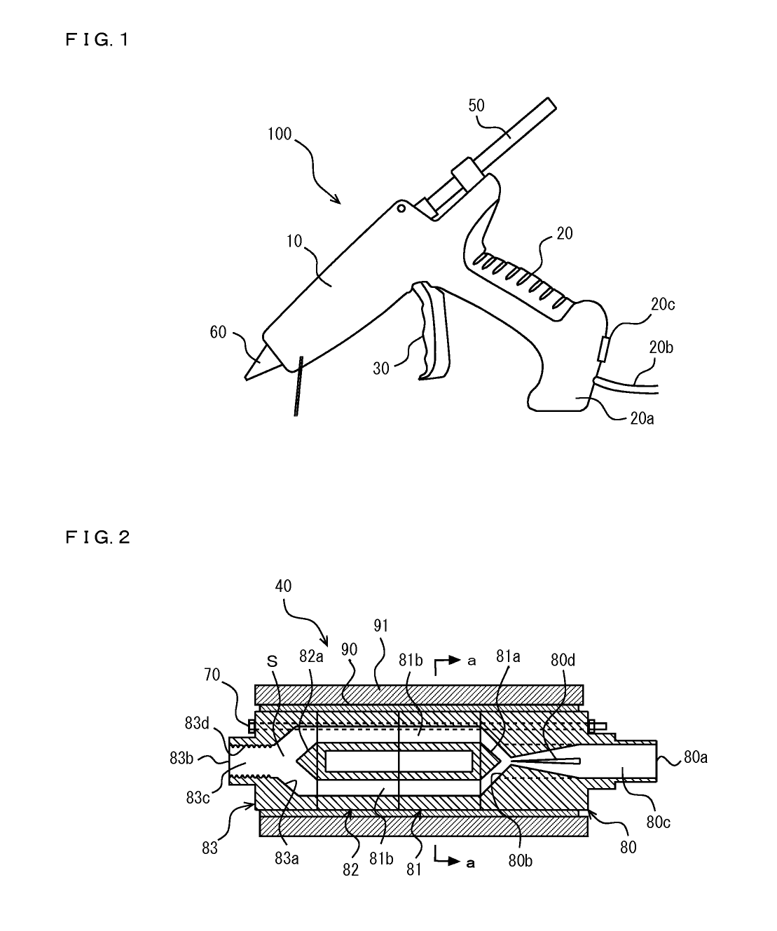

Now, an embodiment of the present invention will be described with reference to the accompanying drawings. FIG. 1 shows an outside appearance of a glue gun 100 according to an embodiment of the present invention. As illustrated, the glue gun 100 has a generally cylindrical main body 10, a handle 20 extending from the glue gun main body 10, and a trigger 30 at a connection between the handle 20 and the glue gun main body 10. The overall shape (outside appearance) of the glue gun is similar to a handgun or pistol.

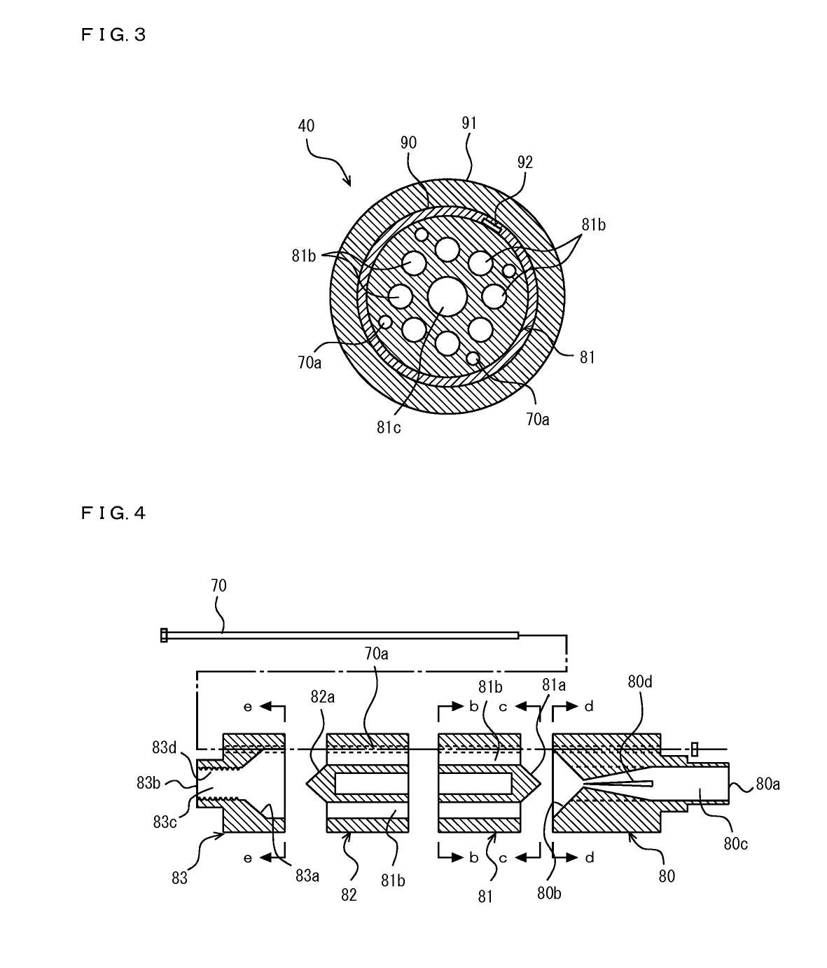

In the glue gun main body 10, there is a built-in melt portion 40 as shown in FIGS. 2 and 3. When the trigger 30 is repeatedly pulled, a stick-shaped hot melt adhesive (glue stick) 50 is introduced continuously into the melt portion 40. The melt portion 40 heats and melts the glue stick 50, and injects the melted glue from a nozzle 60 at a front end of the melt portion 40.

As shown in FIGS. 2 and 3, the melt portion 40 is made from a metal having a good thermal conductivity, such as aluminum, copper or steel, or a ceramics. The melt portion 40 includes four blocks 80, 81, 82 and 83 which are joined (united) in the axial direction by elongated bolts (long screws) 70. The melt portion 40 has a generally cylindrical shape, as a whole. A plate heater 90 surrounds the melt portion 40. As the plate heater 90 generates heat, the entire melt portion 40 is uniformly heated from outside.

The plate heater 90 generates the heat upon receiving an electric current from a power source 20a and a power source cable 20b as shown in FIG. 1. The plate heater 90 is activated and deactivated upon turning on and off of a switch 20c. The temperature of the plate heater 90 is always measured by a temperature sensor 92 disposed in the vicinity of the plate heater 90, as shown in FIG. 3. The temperature of the plate heater 90 is maintained in a predetermine range, for example, from 160 to 200 degrees C. The predetermined range is set arbitrarily.

The plate heater 90 is surrounded by a fireproof insulating material 91 such that the heat of the plate heater 90 does not escape to outside. It should be noted that the bolts 70 are provided opposite sides with respect to the axis of the blocks 80, 81, 82 and 83. At least two bolts 70 are used to join (unite) the four blocks 80, 81, 82 and 83.

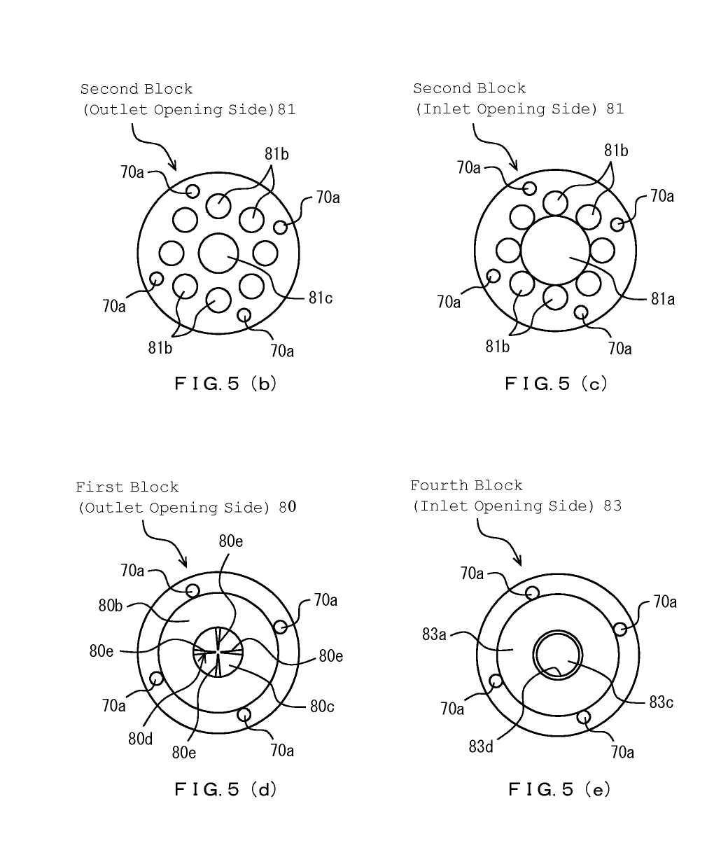

The first block 80 has a generally cylindrical shape. As shown in FIG. 4, the first block 80 has an inlet opening 80a in one end face thereof to receive the stick-shaped hot melt adhesive 50. The first block 80 has a tapered face 80b in the other end face thereof, as shown in FIG. 5(d). The tapered face expands at a certain inclination. As shown in FIG. 4, the center portion of the tapered face 80b communicates with the inlet opening 80a via a first passage 80c. In the first passage 80c, there is provided a cutting blade unit 80d that has a cross shape. In FIG. 5(d), holes, which are designated at 70a, are bolt holes through which the bolts 70 extend. In this embodiment, there are formed four bolts holes 70a, 70a, 70a and 70a.

The cutting blade unit 80d includes four blades 80e, 80e, 80e and 80e. The tip of each of the four blades 80e, 80e, 80e and 80e is pointed (directed) to the axial center of the first passage 80c. The four blades 80e, 80e, 80e and 80e are shifted from each other by 90 degrees along the wall surface of the first passage 80c. As illustrated in FIG. 4, each of the blades 80e, 80e, 80e and 80e has a shape that gradually increases in height from the inlet opening 80a side toward the tapered face 80b side of the first passage 80c.

The second block 81 has a cylindrical shape, which has the same diameter as the first block 80. As shown in FIGS. 5(b) and 5(c), a conical projection 81a is formed at the center portion in one end face of the second block 81. A plurality of passages (eight passages in this embodiment) 81b are formed around the conical projection 81a. Each of the passages 81b has a circular cross-section, and extends to the opposite end face of the second block. A hollow space 81c is formed along the axial center of the second block 81. The second block 81 also has four bolt holes 70a, 70a, 70a and 70a, through which the bolts 70 extend. The third block 82 has a substantially similar shape to the second block 81. The direction is only different, i.e., the direction of the third block 82 is opposite the direction of the second block 81. The third block 82 is joined (united) to the second block 81.

On the other hand, the fourth block 83 has a cylindrical shape with the same diameter as the first block 80, the second block 81, and the third block 82, as shown in FIG. 5(e). A conical tapered face 83a is formed at the center portion in one end face of the fourth block 83. As depicted in FIG. 4, the opposite end face of the fourth block 83 has an outlet opening 83b. The outlet opening 83b protrudes from this end face. The outlet opening 83b communicates with the center portion of the tapered face 83a via a passage 83c.

A thread groove 83d is formed in the wall surface of the passage 83c, which communicates with the outlet opening 83b. Thus, the metallic nozzle 60 is screwed into the outlet opening 83b. The metallic nozzle 60 can be unscrewed. Although the tapered face 83a has the same shape and size as the tapered face 80b of the first block 80, the tapered face 83a is formed at a position several mm—several cm deep inside from the end face of the fourth block 83, as illustrated. The fourth block 83 also has four bolt holes 70a, 70a, 70a and 70a, through which the bolts 70 extend.

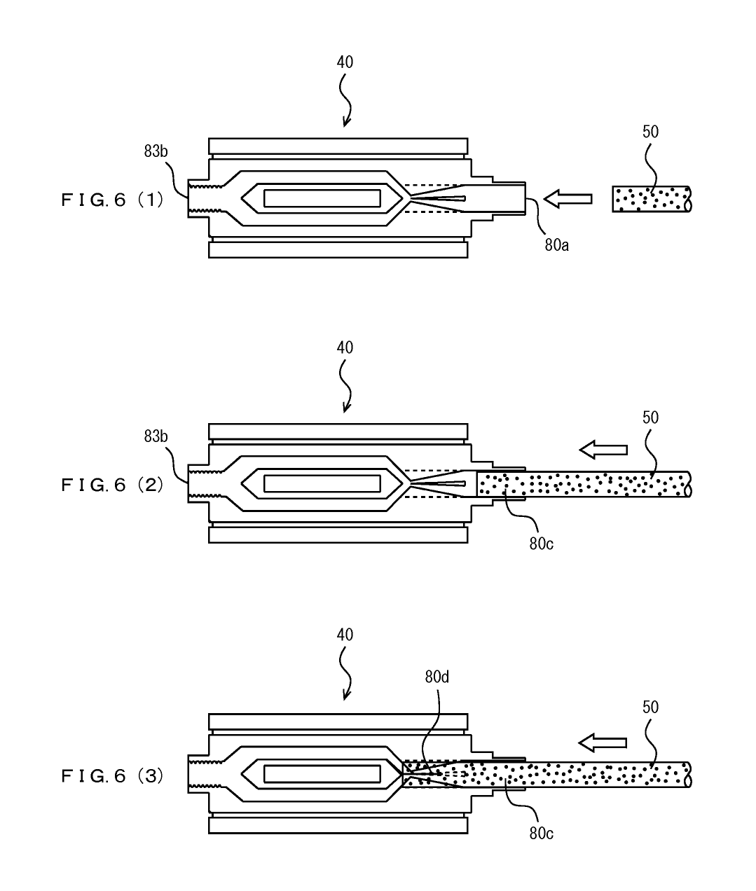

Now, the operation of the glue gun 100 of this embodiment having the above-described configuration will be described. Firstly, the switch 20c of the plate heater 90 is turned on to bring the melt portion 40 into the heating condition. Also, the stick-shaped hot melt adhesive 50 is loaded into the glue gun main body 10, as shown in FIG. 1. Then, the trigger 30 is pulled, and the hot melt adhesive 50 is pushed into the melt portion 40. Accordingly, as shown in FIGS. 6(1) and 6(2), the hot melt adhesive 50 is received into the inlet opening 80a of the melt portion 40 from the front end of the hot melt adhesive 50, and moves in the passage (first passage) 80c toward the outlet opening 83b. As shown in FIG. 8, the cross-sectional shape of the hot melt adhesive 50 does not change very much, i.e., the cross-sectional shape is an original shape (circle).

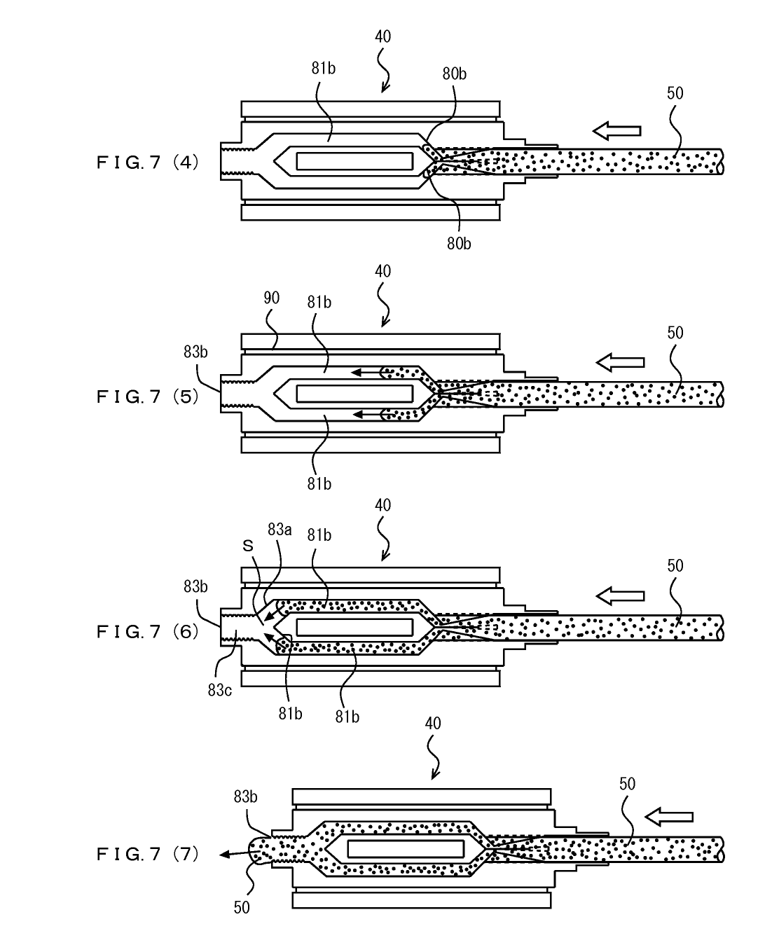

Subsequently, the hot melt adhesive 50 is further pushed in as the trigger 30 is further pulled from the condition shown in FIG. 6(2). Then, as shown in FIGS. 6(3) and 8(3), the cutting blade unit 80d intrudes into the hot melt adhesive 50 from the outer surface of the hot melt adhesive 50. The cutting blade unit 80d cuts the hot melt adhesive 50 in the cross shape in the axial direction, and divides the hot melt adhesive 50 into a plurality of pieces. When the trigger 30 is further pulled from this condition to push (squeeze) the hot melt adhesive 50 inward, the pieces of hot melt adhesive 50 spread radially and move in the conical passage (second passage) defined between the tapered face 80b of the first block 80 and the conical projection 81a of the second block 81, as shown in FIGS. 7(4) and 8(4). It should be noted that the hot melt adhesive 50 is heated immediately after the hot melt adhesive 50 is received in the melt portion 40 from the inlet opening 80a. Thus, the hot melt adhesive 50 is considerably softened before the hot melt adhesive 50 arrives at the second passage. Accordingly, the hot melt adhesive 50 moves through the conical passage (second passage) in a relatively smooth manner.

When the trigger 30 is further pulled from this condition to push the hot melt adhesive 50, the hot melt adhesive 50 branches and flows in the respective passages (third passages) 81b, 81b, . . . , from the conical passage (second passage), as shown in FIGS. 7(5), 7(6), 8(5) and 8(6). The hot melt adhesive 50 flows in the third passages toward the outlet opening 83b. In the meanwhile, the hot melt adhesive 50 is further heated by the heat from the heater 90. Thus, the temperature of the hot melt adhesive 50 rises to a value that can demonstrate a sufficient bonding force when the hot melt adhesive 50 approaches the exits of the respective passages (third passages) 81b, 81b, . . . .

When the trigger 30 is further pulled from this condition to push the hot melt adhesive 50, the hot melt adhesive 50 flowing out of the respective passages 81b, 81b, . . . flows and merges in the space S defined between the conical projection 82a of the third block 82 and the tapered face 83a of the fourth block 83, as shown in FIGS. 7(7) and 8(7). Because the space S defined between the conical projection 82a and the tapered face 83a has a relatively large volume, the hot melt adhesive 50, which has merged in the space S, stays in the space S for a while, and then flows to the outlet opening 83b through the passage 83c. The hot melt adhesive 50 is then injected from the outlet opening 83b, and used for bonding in various uses.

At this timing, the hot melt adhesive 50 is already heated sufficiently. Thus, the hot melt adhesive 50 does not clog at the nozzle 60, and therefore the hot melt adhesive 50 can sufficiently demonstrate the bonding force, which the hot melt adhesive possesses inherently. In practice, because the metallic nozzle 60 is attached to the outlet opening 83b, as described above, the hot melt adhesive is injected in an amount that is decided by the nozzle diameter.

As described above, the glue gun 100 of the present invention includes a plurality of passages 81b, 81b, . . . that connects the inlet opening 80a of the melt portion 40 to the outlet opening 83b of the melt portion 40. Thus, the contact area (heating area) between the hot melt adhesive 50 and the base material (metal having a high thermal conductivity) of the melt portion 40 is increased. It is, therefore, possible to efficiently heat and melt the hot melt adhesive 50, raise the hot melt adhesive temperature to the bonding temperature in a short time, and inject the hot melt adhesive continuously. This prevents the hot melt adhesive 50, which is not sufficiently softened yet, from clogging at or in the vicinity of the nozzle 60. This ensures good bonding work.

Also, it is possible to hold a large amount of hot melt adhesive 50, which is heated, melted and has reached the bonding temperature, in the melt portion 40. Unlike the conventional technology, therefore, it is not necessary to prepare two glue guns and use them alternately. The single glue gun 100 of the present invention can continuously inject the adhesive, and ensure efficient bonding work. This makes it possible to use the glue gun of the present invention in industrial use that requires the continuous injection of the adhesive in a large amount. It should be noted that although the hot melt adhesive is divided into a plurality of pieces by the cutting blade unit 80d having the cross shape in the illustrated embodiment, the number of the blades 80e of the cutting blade unit 80d is not limited to four, i.e., the number of the blades 80e may be greater than four or smaller than four.

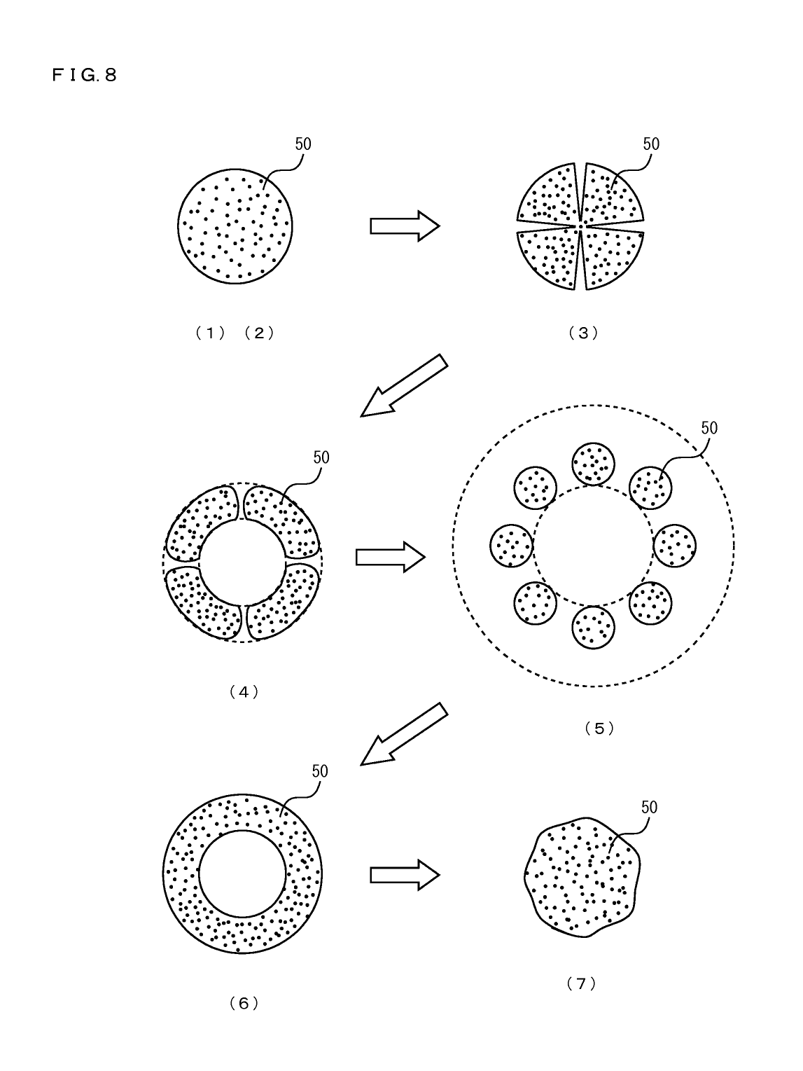

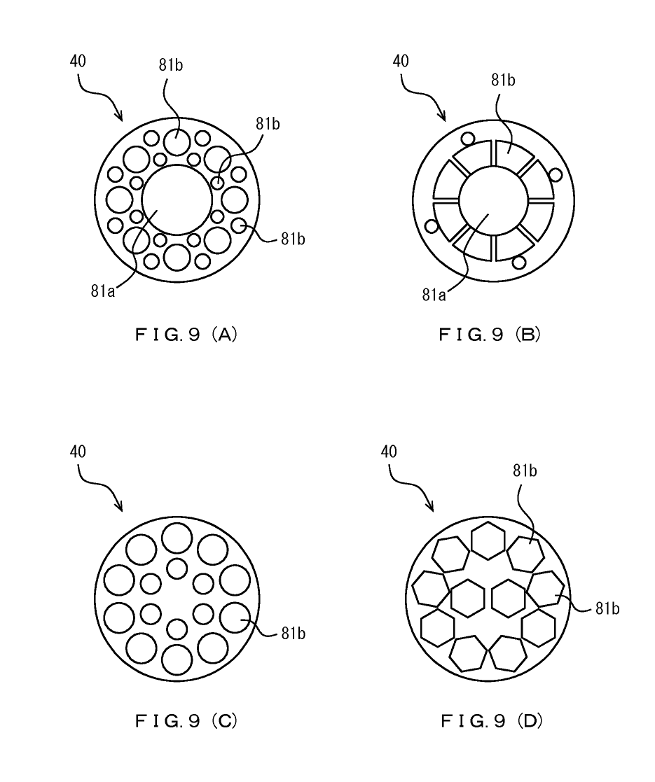

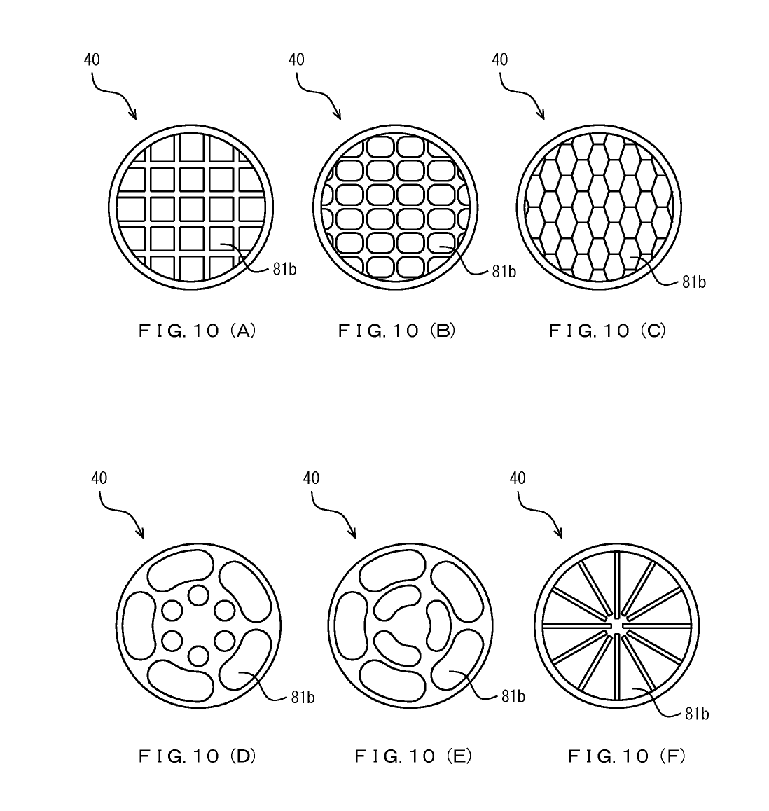

It should also be noted that the configuration of the branching passages (second passages) 81b is not limited to that shown in FIGS. 5(b) and 5(c). For example, as shown in FIG. 9(A), a plurality of large and small passages (second passage) 81b may be provided. Also, the cross-sectional shape of each of the second passages 81b is not limited to the circle. For example, as illustrated in FIG. 9(B), the cross-section of the second passage 81b may have a fan shape (rectangular shape). Alternatively, as shown in FIG. 9(C), the passages (second passages) 81b may also be provided near the center of the melt portion 40. Alternatively, as shown in FIG. 9(D), the cross-section of each second passage 81b may have a polygonal shape (hexagon in the drawing). Alternatively, as shown in FIG. 10, the cross-section of the second passages 81b may have other shapes, such as a lattice shape, a honeycomb shape, or an oval shape.

In the above-described embodiment, the melt portion 40 has the four blocks 80, 81, 82 and 83. However, the number of the blocks is not limited to four. The number of the blocks may be more than four or less than four. The melt portion 40 has the hollow portion 81c along the center axis thereof. Thus, a separate heater may be disposed in the hollow portion 81c to heat the hot melt adhesive from the center axis of the melt portion. Alternatively, the hollow portion 81c may be dispensed with.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### REFERENCE NUMERALS AND SYMBOLS

100: Glue gun
10: Glue gun main body
20: Handle
30: Trigger
40: Melt portion
50: Hot melt adhesive
70: Bolt
70a: Bolt hole
80: First block
80a: Inlet opening
80b: Tapered face
80c: Passage (first passage)
80d: Cutting blade unit
81: Second block
81a: Conical projection
81b: Passage (second passage)
81c: Hollow portion
82: Third block
82a: Conical projection
83: Fourth block
83a: Tapered face
83b: Outlet opening

1. A glue gun comprising a melt portion configured to receive a stick-shaped hot melt adhesive, and then heat, melt, and inject the hot melt adhesive,
the melt portion having an inlet opening to receive the stick-shaped hot melt adhesive, and an outlet opening to inject liquid hot melt adhesive, said liquid hot melt adhesive being prepared by heating and melting the stick-shaped hot melt adhesive, said inlet opening communicating with said outlet opening via a plurality of passages.

2. The glue gun according to claim 1 further including a cutting blade unit disposed at the inlet opening and configured to cut the hot melt adhesive radially, with an axis of the hot melt adhesive being a center of cutting.

3. A glue gun comprising a melt portion configured to receive a stick-shaped hot melt adhesive, and then heat, melt, and inject the hot melt adhesive,
the melt portion having an inlet opening to receive the stick-shaped hot melt adhesive, and an outlet opening to inject liquid hot melt adhesive, said liquid hot melt adhesive being prepared by heating and melting the stick-shaped hot melt adhesive,
said glue gun comprising:
a cutting blade unit disposed in a first passage extending inward from the inlet opening, and configured to cut the hot melt adhesive radially, with an axis of the hot melt adhesive being a center of cutting;
a second passage formed downstream of the first passage, the second passage having a conical shape and configured to spread the hot melt adhesive radially from a center of the hot melt adhesive while guiding the hot melt adhesive to a downstream side; and
third passages extending from the second passage toward the outlet opening, the third passages being arranged in a generally annular form, the third passages merging with each other near the outlet opening and communicating with the outlet opening.

4. The glue gun according to claim 3, wherein the third passages have a larger volume on a downstream side than on an upstream side.

5. The glue gun according to claim 3, wherein the third passages are a plurality of passages that are separate in a circumferential direction of the generally annular form.

6. The glue gun according to claim 5, wherein each of the plurality of passages is circular in its cross-section.

7. The glue gun according to claim 3, wherein the cutting blade unit includes a plurality of blades that extend from a wall of the first passage toward a center of the first passage, and each of the plurality of blades gradually increases its height from an upstream side of the first passage to a downstream side of the first passage.

8. The glue gun according to claim 3 further including a plate heater that extends around a substantially entire outer surface of the melt portion.

9. The glue gun according to claim 4, wherein the third passages are a plurality of passages that are separate in a circumferential direction of the generally annular form.

10. The glue gun according to claim 4, wherein the cutting blade unit includes a plurality of blades that extend from a wall of the first passage toward a center of the first passage, and each of the plurality of blades gradually increases its height from an upstream side of the first passage to a downstream side of the first passage.

11. The glue gun according to claim 5, wherein the cutting blade unit includes a plurality of blades that extend from a wall of the first passage toward a center of the first passage, and each of the plurality of blades gradually increases its height from an upstream side of the first passage to a downstream side of the first passage.

12. The glue gun according to claim 6, wherein the cutting blade unit includes a plurality of blades that extend from a wall of the first passage toward a center of the first passage, and each of the plurality of blades gradually increases its height from an upstream side of the first passage to a downstream side of the first passage.

13. The glue gun according to claim 4 further including a plate heater that extends around a substantially entire outer surface of the melt portion.

14. The glue gun according to claim 5 further including a plate heater that extends around a substantially entire outer surface of the melt portion.

15. The glue gun according to claim 6 further including a plate heater that extends around a substantially entire outer surface of the melt portion.

16. The glue gun according to claim 7 further including a plate heater that extends around a substantially entire outer surface of the melt portion.
